(19) United States
(12) Patent Application Publication
(10) Pub. No.: US 2005/0114228 A1
(43) Pub. Date: May 26, 2005

(54) Request for quotation electronic commerce shopping cart

(76) Inventor: Vinod Wadhwani, Washington, DC (US)

Correspondence Address: VINOD WADHWANI, 1734 P STREET, NW # 52, WASHINGTON, DC, 20036, US

(21) Appl. No.: 10/996,094

(22) Filed: Nov. 24, 2004

Related U.S. Application Data
(60) Provisional application No. 60/524,024, filed on Nov. 24, 2003.

(51) Int. Cl. G06F 17/60

(52) U.S. Cl. 705/26

(57) ABSTRACT

The Request for Quotation Shopping Cart System takes products and services with no predetermined price and allows them to be sold on the Internet. The invention accomplishes this by creating an intermediate step whereby the software or a human administrator intervenes to set the price based on a number of factors. Once either the administrator or the software has set the price, a notification is sent back to the customer and they may proceed with the purchase of the product or service as they would any good commonly sold on the Internet today.

This application claims benefit of Provision Application No. No. 60/524,024 filed Nov. 24, 2003.

### TECHNICAL FIELD

The present invention is related to electronic merchandise catalogue and ordering systems for use on the internet/intranet. In particular, the present invitation is directed to the facilitation of purchasing goods over internet/intranet whose price can vary by customer, inventory, risk, quantity, or time.

### BACKGROUND ART

Consumers have already discovered the advantages of shopping from their homes by the use of catalogues, television shopping channels or by computer transaction systems. There are numerous public internet web sites and private intranet sites that offer various articles and services for sales. All of these public web sites and private sites operate by offering products and services to customers at a particular fixed price.

There are a number of transaction systems using electronic communications, including the internet, as conduits for carrying out an exchange of goods and funds. The conventional technology includes a number of examples containing some relevant elements for a transaction for goods or services to be sold at a predetermined price.

U.S. Pat. No. 5,319,542 to Kind, Jr. et al., teaches a system for ordering items using an electronic catalog stored on a publicly accessible database. The patent includes a description of a related scheme of online catalogs provided by the Prodigy Corp., as set out in col. 1, beginning with line 26. The use of the Prodigy system suggests the use of the internet for providing both catalog information and as a conduit for entering electronic purchase orders to be sent to the vendors. A key aspect of the catalog system is that both public and private catalogs can be maintained. Both can be updated electronically, presumably through the internet since other methods are not described. The catalog system includes provisions for pre-negotiated prices and predetermined shopping lists for specific customers.

In conventional internet or intranet transaction systems the customer is provided with a predetermined price for a product or service. For companies that engage in business where multiple considerations prohibit listing a fixed price there is no current means of consummating a transaction over the internet or intranet. If there are products or services for sale where prices vary by customer, inventory, risk, quantity, or time the only current solution is to request a quotation by email, fax, or telephone.

### SUMMARY OF THE INVENTION

Therefore, it is one object of the present invention to allow the web site administrator to consolidate all the disparate components of a sale whereby a buyer can go shopping by computer for almost any product or service that is for sale.

It is another object of the present invention to take into account historical data and eliminate the role of a web site administrator so that the software itself may create a fixed price for products or services based on past behavior of the web site administrator.

It is a further object of the present invention to provide a transaction system whereby a buyer can purchase a product or service that initially did not have a fixed price using standard electronic commerce techniques.

It is still a further object of the present invention to seamlessly consolidate all the disparate components of a sale in real-time without the time lag associated with a traditional email, fax, or telephone request for quotation.

These and other objects of the present invention are achieved by a system that allows customers using a computer to obtain pricing for items that have not been assigned a fixed price. To price these items, there is an interaction between a web site administrator and the customer in which an administrator converts variables presented by the customer and System into a fixed price. The software then notifies the customer that a price has been assigned after which, if the customer chooses, he can initiate the order for the selected product or service.

Taking into account transaction and historical data, the software can make this interaction automatic, without the intervention of a web site administrator. The end result is that the RFQ Cart software can dynamically price items that otherwise do not have predetermined prices.

### BRIEF DESCRIPTION OF THE DRAWINGS

FIG. 1 is a flow chart depicting the first stage of the operation of the transaction system of the present invention in which the customer first interacts with the software.

FIG. 2 is a flow chart depicting the second stage of the operation of the transaction system of the present invention in which the system and, if required, the administrator convert a variable price into a fixed price.

FIG. 3 is a flow chart depicting the third stage of the operation of the transaction system of the present invention in which customer is presented with the choices based on the results of the actions performed in the operation depicted in the second stage.

FIG. 4-1 is a screen capture of the system showing results of items for sale. Some of these items do not have a fixed price. It corresponds to item 4 in FIG. 1.

FIG. 5-1 is a screen capture of the system showing items that in both the standard shopping cart and the request for quotation shopping cart. It corresponds to item 5 in FIG. 1.

FIG. 6-1 is a screen capture of the system showing the items from both the standard and request for quotation shopping cart consolidated into the request for quotation cart. It corresponds to item 6 in FIG. 1.

FIG. 7-1 is a screen capture of the system showing user added comments. It corresponds to item 7 in FIG. 1.

FIG. 8-2 is a screen capture of the system showing the administrator setting a price for the quote request.

FIG. 9-2 is a screen capture of an email sent by the system to the customer that presents the quotation and means, via URL, to respond to it.

FIG. 10-3 is a screen capture of the system showing the customer viewing the quote with the now fixed prices.

### DETAILED DESCRIPTION OF THE PREFERRED EMBODIEMENTS

All of the products available for sale on the Internet today come attached with a fixed and defined price. This is to be expected in the consumer economy where no person is will to purchase an item without knowing exactly how much it will host him or her.

However, problem is introduced when organizations are asked to interface with other organizations via the Internet. Many organizations that sell products or services do so knowing only that they must maximize the amount of profit they realize from the customer without jeopardizing the sale. They must evaluate the cost of the product against the liquidity of the market, the strength of the product supplier, the strength of the customer, potential risks of sale, and other factors to determine how much to quote for a particular product or service. Table 1 shows some of the factors that a salesperson may consider when determining how to price a product.

TABLE 1
Factors that Administrators consider when setting prices.

| | | | |
|---|---|---|---|
| Customer | Supplier | Cost of | Order |
| Relationship | Price | product or | Quantity |
| | | service | |
| Quantity in | Payment | Management | Competition |
| Stock | terms | incentives | |
| Political | Complexity | Geography | Financial |
| risk | | | Risk |

The current process by which these quotes are handled is as follows:
1. Phone call, fax, or email sent to manufacturer of product or provider of service
2. Evaluation by manufacturer/provider based on variables such as those in Table 1.
3. Proposal or quotation sent by email, mail, fax, or phone call.
4. Acceptance or rejection of quotation or proposal by potential customer.
   This process is time consuming and may involve communication costs.

The Request For Quotation (RFQ) Shopping Cart System allows customers to search for and add items as they would a standard shopping cart. The product or service in question can be searched or browsed and selected in the same manner as commonly used on web pages on the Internet.

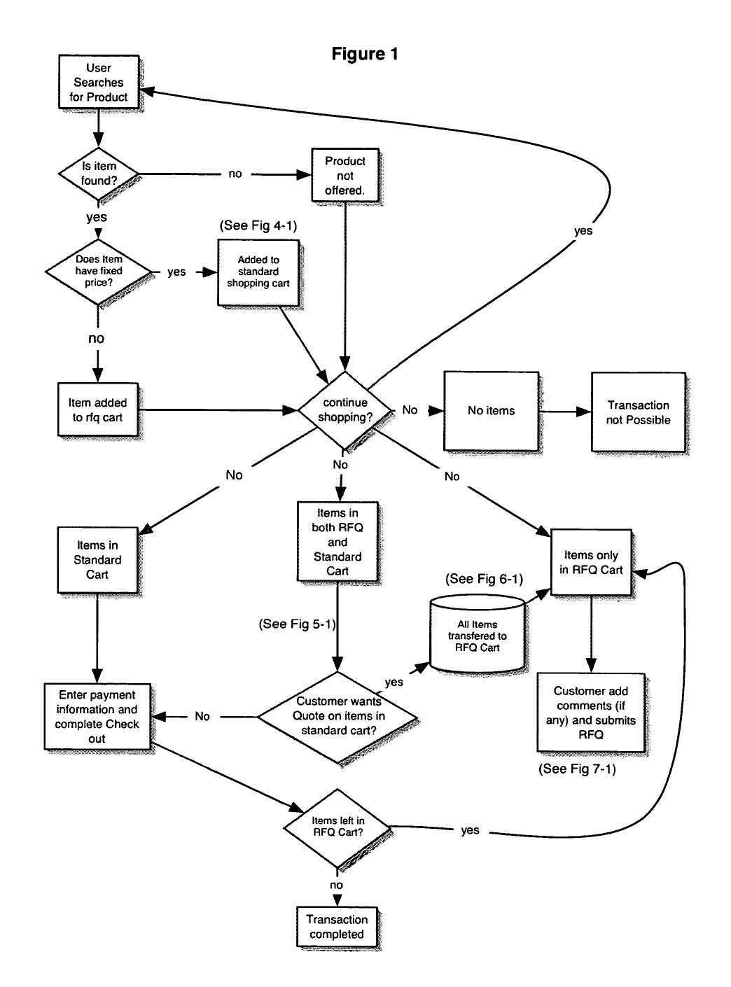

Once the product or service is found, if it does not have a fixed price associated with it, the customer may select to add it to the RFQ Cart. At the option of the web designer, the RFQ Cart may be shown on the web page along with a standard Shopping Cart. (Depicted in FIG. 5-1.) The distinction between the two types of carts is that the RFQ Cart allows items without prices to be added to it, while the standard Shopping Cart requires that its contents all have fixed prices associated with them. It should be noted that at any time while the customer is selecting the products and/or services they desire, they may also choose to move any products or services from the standard Shopping Cart to the RFQ Cart. The software enables this to happen at the choice of the Web Site Administrator, to allow the customer to request a discount based on order quantity or any other special consideration they may have in mind.

If there are items in both the RFQ Cart and the standard Shopping Cart then the System will prompt the user as to whether they would like to transfer the contents of the standard Shopping Cart to the RFQ Cart. If the customer chooses not to then the System will use the procedures similar to those found on many Web Sites today to execute the standard Shopping Cart and will, when possible, concurrently add the processes required to execute the RFQ Cart.

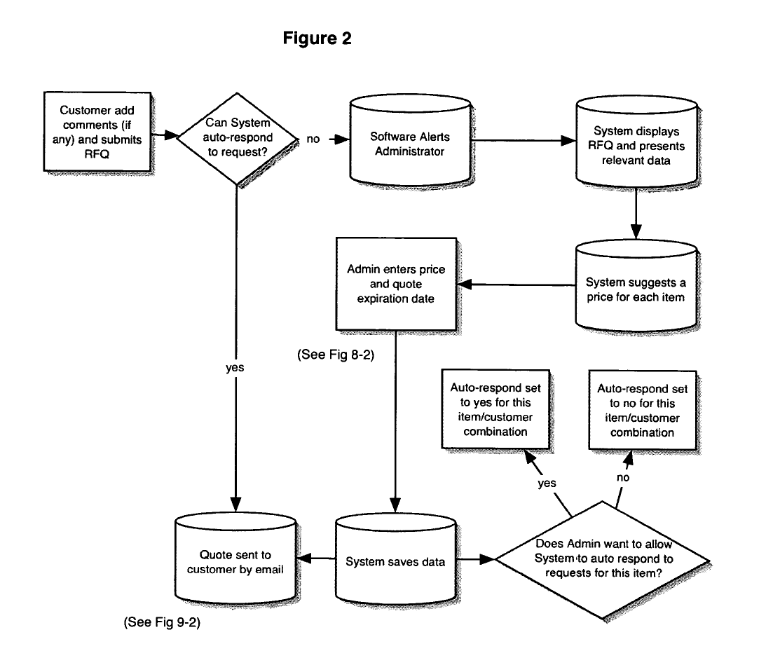

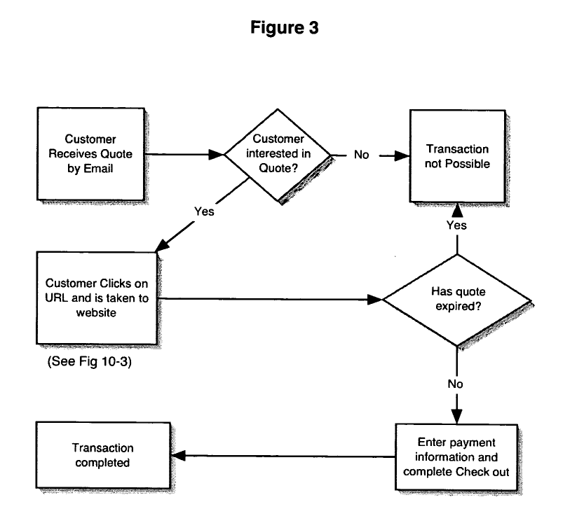

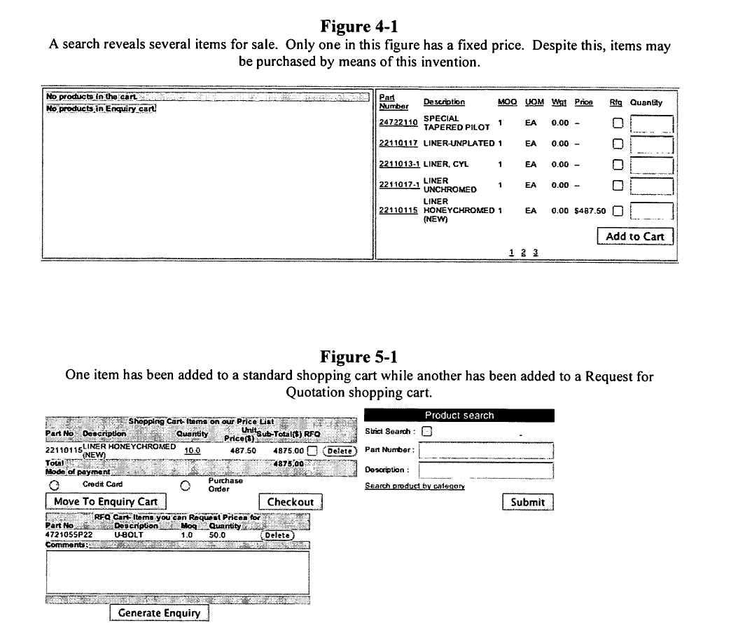

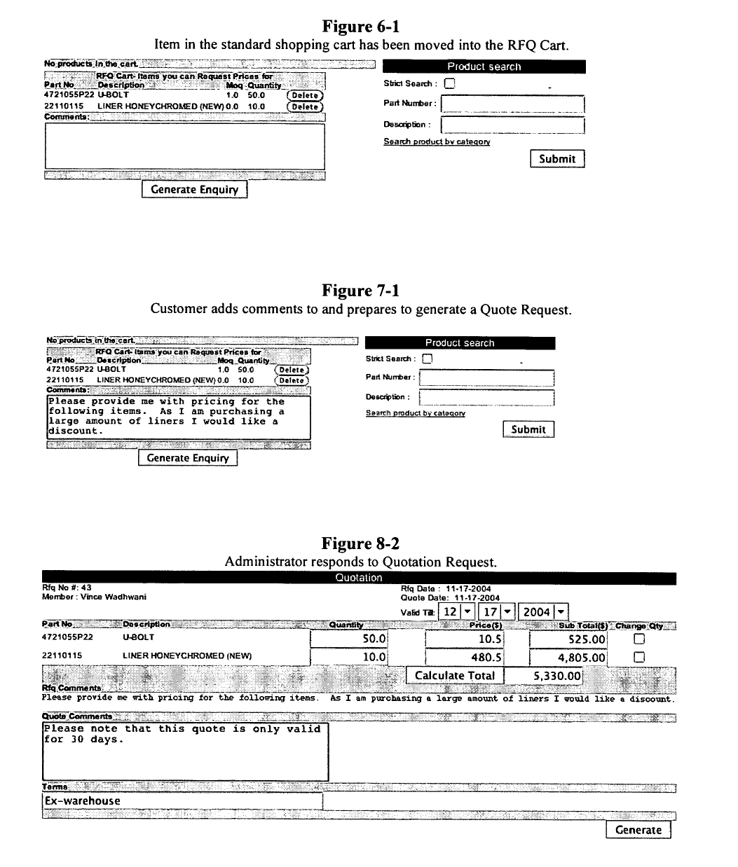

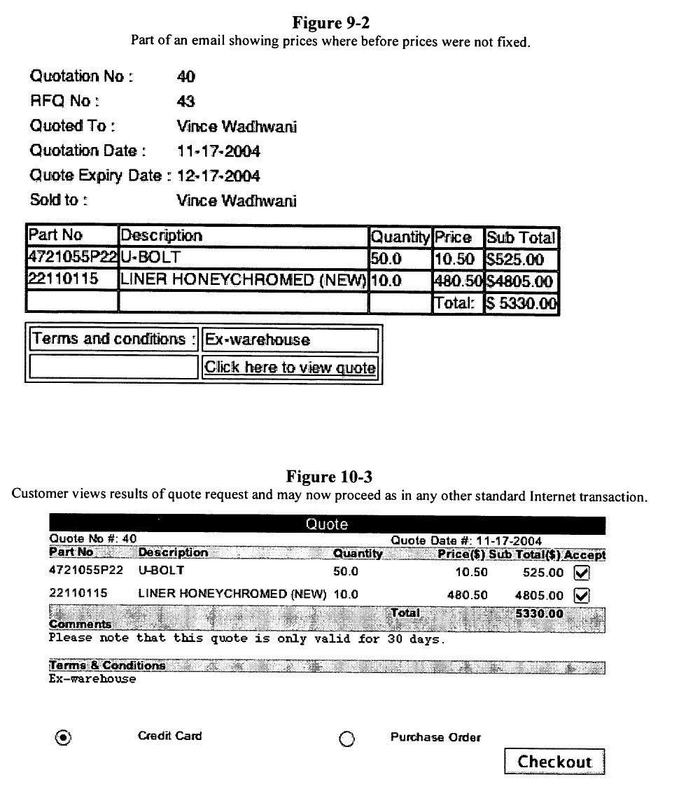

The process involved in executing the RFQ Cart comprises:
1. Confirming whether to transfer items from standard Shopping Cart to RFQ Cart.
2. Allow customer to add note to Web Site administrator as depicted in FIG. 7-1.
3. Request for Quotation submitted
4. System sends RFQ to appropriate individual (herein after referred to as Salesperson) within organization based on rules set by Web Site administrator
5. System displays PFQ to Salesperson along with relevant data as depicted in FIG. 8-2.
6. Based on statistical methodology, the System will recommend a price to the Salesperson if enough historical transaction data is available.
7. The Salesperson fills in the field(s) corresponding to a price for the items in the RFQ Cart and sets any rules he or she deems necessary to preserve the integrity of their quotation.
8. The System notes the prices and rules for future reference, assigns the prices given by the Salesperson to the items in question, transfers those items along with the corresponding prices to the standard Shopping Cart and sends a link to the customer for them to access the results.
9. The customer may, upon receiving notification from the System, review the contents of the standard Shopping Cart to see prices on the items they requested pricing for. Since those items now have fixed prices, the common standard Shopping Cart procedures may now be used to execute the order. FIG. 10-3 depicts a standard shopping cart populated by items that did not have a predetermined price.

The customer may have options available to them (e.g. removing items, reducing quantities) as long as the Salesperson opted to grant them those privileges based on the rules set in Step 8.

Further to step 6 described above, if the System has enough valid data to recommend a price, the System Administrator or Sales Person may opt to allow the System to automatically and immediately respond to the RFQ for the item in question, making it a Fixed-price item. The System takes into account historical transaction data comprising previous quoted price, date of quotation, product or service, and quantity on a customer-by-customer basis.

The following example transaction has been provided to demonstrate the process used by the invention:

John Doe works for a railroad and is seeking to purchase some items to replenish the stock he keeps in case his engine has trouble. He logs onto a web site and searches for the Stock Keeping Unit (SKU) corresponding to the piston ring his locomotive uses. Note that this can be done either based on a numerical representation of the SKU, such as a part number or serial number, or a description of the SKU.

The System logs his search and responds by showing the piston ring he asked for. The System informs him that the price for this item is not fixed and, upon completing his session, a price will be assigned to the rings based on his requirement.

John decides to order 8 sets to satisfy his requirement for 6 months. The System adds 8 Piston Ring sets to the RFQ cart and waits for John's next action. Since this was all he needed for the moment, John clicks the checkout link.

The Company running the web site has opted not to allow messages to go with the RFQ, therefore the System assigns an RFQ number to John's request and checks its rules. Finding that all inquiries coming from Rail customers go to Sally, the System sends Sally an email asking her to review the quotation. At the same time, the System sends an email to John confirming that he has requested a quote for 8 Piston Ring Sets.

Before Sally received the email, she happened to log into the System and saw that there was a quote that was awaiting her review and response. Clicking on the link in her web browser, she quickly sees the details of the quote including John's purchase history with the company, the current level of stock of the Piston Rings in question, the last sale price of those rings to John, as well as some other data that she quickly passes on. Sally's numbers have been low this year and she needs this sale badly. John is not a big customer and her cost has increased slightly but she decides to pass along last years price to him.

The System notes the price and cost of the items along with the end customer and logs the information in its database to be used and analyzed in the future. For this quote, the System did not have enough data to accurately recommend a price. After logging all the required information about the transaction, the System populates a price for the Piston Ring and sends an email to John with the Quote and a link to follow to purchase the item.

John clicks the link and the System takes him to the Corporate web site where the RFQ cart is now empty, replaces with a Fixed Price cart showing 8 Piston Rings for $100.00. Delighted to be getting the same price as last year, John proceeds to type in his credit card number and checkout.

The System, notes that John has viewed the RFQ and also purchased products based on this price. It will use this information the next time a customer requests a quote for this Piston Ring set. Eventually the System will recommend a price to Sally making her job of analyzing the historical data unnecessary.

1. A computer implemented process for carrying out an Internet transaction with no predetermined price comprising:
Running a transaction program on a computer system so as to integrate processes including:
a. Displaying search results for products or services that do not have a predetermined price;
b. Selecting products or services which do not have a predetermined price and storing them in a request for quotation shopping cart specifically designed for this purpose;
c. Allowing for a product or service with a fixed price to be instead listed as unfixed for the purposes of further negotiation;
d. Accessing at least one local or remote database for obtaining
i. Transaction history for the product or service to be purchased; and
ii. Price information for the product or service to be purchased; and
iii. Transaction history for the customer requesting the product or service; and
iv. Inventory level for the product to be purchased; and
e. Calculating a sales price for a product or service based upon transaction history for the customer, product or service, quantity, and inventory level.
f. Fixing a price for a product or service based upon the calculation by the system or manual entry by an administrator; and
g. Upon fixing of the price for a product or service, the generating of a standard shopping cart from which products or services are moved from the request for quotation shopping cart.
h. Receiving an order for the products or services thereby triggering an electronic process for confirming existence of available funds; and
i. Upon confirmation of availability of said funds, accepting said order, generating an electronic record; and
j. Storing electronic data associated with the transaction comprising
i. Quoted price for the product or service
ii. Customer information
iii. Quantity of product or service requested
iv. Quantity of product or service sold
v. Inventory level at time of quotation

2. The process of claim 1, further comprising: determining whether the product or service to be purchased in fact involves an undetermined price.

3. A system of carrying out a commercial transaction over a network of computers, the system comprising:
a. Means for receiving a selection of a product or service to be purchased.
b. Means for accessing at least one local or remote database for
i. Transaction history for the product or service to be purchased; and
ii. Price information for the product or service to be purchased; and
iii. Transaction history for the customer requesting the product or service; and
iv. Inventory level for the product to be purchased;
c. Means for calculating a sales price for a product or service based upon transaction history for the customer, product or service, quantity, and inventory level.
d. Means for fixing a price for a product or service based upon the calculation by the system or manual entry by an administrator; and
e. Upon fixing of the price for a product or service, means for generating of a standard shopping cart from which products or services are moved from the request for quotation shopping cart.
f. Means for receiving an order for the products or services thereby triggering an electronic process for confirming existence of available funds; and
g. Upon confirmation of availability of said funds, means for accepting said order, generating an electronic record; and
h. Means for storing electronic data associated with the transaction comprising
i. Quoted price for the product or service
ii. Customer information
iii. Quantity of product or service requested
iv. Quantity of product or service sold
v. Inventory level at time of quotation

4. The system of claim 3, wherein at least one database stores customer data, goods available for transaction, and historical transaction information.

5. The system of claim 3, further comprising means for storing and analyzing data based upon each customer accessing the system to develop a purchasing profile for each customer.

6. They system of claim 3, further comprising means for storing and analyzing data based upon each product or service within the system to develop a pricing model for each respective product or service.
